(19) United States
(12) Patent Application Publication
(10) Pub. No.: US 2011/0069107 A1
(43) Pub. Date: Mar. 24, 2011

(54) Media Coating Formulation for Contact and Non-Contact Printing

(76) Inventor: Paul Herbert DeWyngaert, III, Gloucester, MA (US)

(21) Appl. No.: 12/876,204

(22) Filed: Sep. 6, 2010

Related U.S. Application Data
(60) Provisional application No. 61/240,263, filed on Sep. 7, 2009.

(51) Int. Cl. B41J 2/015; C09D 11/02; B41M 5/00

(52) U.S. Cl. 347/20; 106/31.6; 428/32.1; 347/100

(57) ABSTRACT

A method to produce and use a coating which when applied to a media and used in the graphics industry with a contact or non-contact method of printing, will allow for efficient use of water, oil, or solvent based colors which at present requires 3 types of coating. The coating can be applied with any commercial or non-commercial method (such as but not limited to roller, spray, gravure, blade or by incorporating the coating into or onto the media during the manufacturing process of the media). The coating when applied increases the absorption of the color which will reduce the drying time and produces a smother print surface of the media. The coating will also result in a faster release of the color from the media in the case of transfer use.

### CROSS REFERENCE TO RELATED APPLICATION NO. 61/240,263

The present application is a non-provisional application.

This application claims benefits of provisional application No. 61/240,263 filed on Sep. 07, 2009.

### INVENTION SUMMARY

This coating provides an efficient surface when applied to a media or carrier and used in the graphics industry with a contact or non-contact method of printing applying an image that will be transferred to another surface or substrate utilizing any or all of the following variables: Heat, Pressure, and/or time. The coating may also be used to enhance the quality and performance of a non-transferred image such as a photographic quality print or standard quality non-contact print. The coating is designed to be applied either onto an existing media surface after the media has been produced or manufactured, or during the actual process of producing or manufacturing the media. The method of coating can be any commercial or non-commercial method such as but not limited to roller, bar, spray, fountain and or by incorporating the coating into the base formula of the media itself. This coating will allow for smoother finish, higher efficiency of the dye, colorant, pigment or other system of applying the image or graphic, faster absorption and or drying of the color system as well as a more efficient color release in the case of the use of transfer coating.

### INVENTION DESCRIPTION

This invention is very efficient in holding color, very efficient at drying or absorbing the color, and very efficient at releasing the color when used in a transfer process to apply or release the color to another surface or substrate. This coating is very unique in that it works well with all three (3) conventional color systems at this point (i.e. water, oil, and solvent based systems). All other coatings available at this point are specific for a particular color system which requires manufacturers and customers to have multiple media's depending on the printing method and color system used. This coating when applied allows for a reduction in the inventory and an increase in efficiency during the actual printing process. Then invention also works to reduce lateral bleed during and after the printing process, allows for a reduced use of color during the printing process to achieve a desired color, makes the media more stable during the printing process and when used for transfer application—keeps the media more stable during the transfer process which helps to prevent cockling or buckling. This invention works by balancing the materials involved in the production of the coating to allow for maximum surface area which functions as a type of storage cell for the color, balancing the materials involved to allow for quick absorption or drying of the colors used within the combination of material used to make the coating which removes the color away from the surface allowing for a faster process speed or time during the printing process. The combination of materials used to make the coating allows for the use of multiple color systems without the need for the different coatings required for each color system. This invention is very unique in its ability to be used with all of the currently available color systems which reduces the need for multiple inventories of media's for each specific color system. This invention is usable on all sizes of media and with all printing methods both contact and non-contact.

Coatings currently available are specific for a particular color system resulting in higher inventory costs and longer more difficult processing time to balance the colors of the different systems (oil, water, solvent). Today's coatings also require more costly production as the coating must be purged from the system at the end of use on a given media to then introduce the new functional coating into the coating line for another color system whether it be oil, water, or solvent. With this invention, it is not necessary to purge or flush the system as the same coating will be used for coating the entire run of media regardless of the type (oil, water, solvent) to ultimately be used on the media. No other coating has this capability. This invention also maintains the ability to have a high color release, high color retention to the surface of the coated media, fast dry and or absorption, as well as very good resolution and the ability to slow down and or prevent lateral bleed in or on the surface of the coated media.

The invention allows for the use of any commercially available color system without changing the coating to match the system used in the contact or non-contact printing method.

### Improvements on Pre-Existing Inventions

Coatings currently in use are color system specific which means that an oil system requires a coating suited for that system; a solvent system requires a coating suited to that system, and a water system requires a coating suited for that system. This invention does not require a different coating for each system. This coating functions equally well with all three systems (oil, water and solvent), without a change in the coating itself. No other coating offers this ability.

### Other Uses or Applications for this Invention

This coating has also been found to provide a good printing surface for printing methods other than the typical transfer system using any or all of the following variables: heat, pressure, time. Other methods of contact and non-contact printing such as photographic quality, documents, and standard quality where high resolution, clean color, even color saturation or density, and fast drying are needed.

1. A coating for use with disperse dye, sublimable dye, or other such dye or pigment inkjet or direct print application to one or both sides of a paper to allow the paper to be used as a transfer paper in a process involving heat, pressure or, vacuum and time as variables to achieve sublimation of the image or transfer of the image to a secondary media or substrate. The coating may be applied to the wire side or the felt side of the paper or other media used as the base. The coating may also be used on both the wire and the felt side depending on the application and process to apply the coating. The coated, at lease on the side of said base paper to be printed by ink jet, digital printers, or other conventional printing methods wherein said coating has a porosity of at most 150 ml/mm. and contains filler, and said release layer is designed not to be transferred along with the ink; and wherein a non-transferable dye is added to the non-printed side or to the base paper for grade identification and manufacturing identification.
a) A coating composition applied on at least one of the first side or the second side of the paper at a coat weight of about 4.5 lbs./3,000 sq. ft. based on a dry weight of the coating composition with the coating composition comprising:
(i) At least about 5 wt. % silica based on the dry weight of the coating composition; and
(ii) At least about 5 wt. % binder based on the dry weight of the coating composition

2. A coating which can be applied to either the wire side or the felt side allowing the paper to be used with various dyes or pigments in a transfer process according to claim 1.

3. A coating applied to paper according the claim 1, wherein the porosity is at most about 100 ml/min of the coating and paper.

4. A coating applied to paper according to claim 1, wherein the porosity is between about 0 and about 50 ml/min of the coating and paper.

5. A coating applied to paper according to claim 1, wherein the coating is based on Silica, Silica Gel, Calcine Clay, Calcium Carbonate, Acrylic emulsion, Polyvinyl Alcohol or a mixture thereof.

6. A coating applied to paper according to claim 5, wherein the coating is based on Silica Gel, Calcine Clay, Calcium Carbonate or a mixture thereof.

7. A coating according to claim 1, within the coating composition comprises and 5 wt. % to about 40 wt. % silica based on the dry weight of the coating composition.

8. A coating according to claim 1, wherein the coating composition comprises about 5 wt. % to about 40 wt. % binder.

9. A coating according to claim 1, wherein the coating composition further comprises filler comprising at least one of clay, calcium carbonate, or a mixture of clay and calcium carbonate.

10. A coating applied to the non-print side, according to claim 1, of the paper which may differ from the coating applied to the print side which may have a non-transferrable color or marker identification of the product itself.

11. A coating according to claim 1, which may be applied by any method to one or both sides of a media or substrate to be later used as a dye carrier in a non-contact print method such as ink jet or other form of digital printing.

12. A coating according to claim 1, wherein the coating is applied to the media at a coat weight of about 3 lb./3000 sq. ft. to about 8 lb./3000 sq. ft. based on the dry weight of the coating composition.

13. A coating according to claim 1, which may be applied to any media or substrate which has the ability to be placed in contact with another media or substrate (which is called the receiver) allowing for the dye to sublimate or transfer from the host media (a coated and non-contact printed media or substrate), to the receiver media or substrate.

14. The sublimation or transfer of the dye from the host media or substrate to take place in the presence of heat, pressure and time and or any combination of the three (3).

15. A coating according to claim 1, to be applied to a media or substrate comprising:
(a) A non-contact printable side, and
(b) A second non-contact printable side and or a non-printable side, and
(c) The non-contact printable side to have a coating weight of about 1 lb./3000 sq. ft. to about 6 lb./3000 sq. ft. based on a dry weight of the coating composition, and the composition comprising:
(i) at least 50 wt. % filler based on the dry weight of the coating composition, wherein at least about 15% of the filler comprises silica based on the weight of the filler; and
(ii) at least 5% wt. binder based on the dry weight of the coating composition.

16. A coating according to claim 15, wherein the filler comprises clay, calcium carbonate or a mixture of clay and calcium carbonate.

17. A coating according to claim 15, wherein the coating composition comprises about 30 wt. % to about 85 wt. % filler based on the dry weight of the coating composition.

18. A coating according to claim 15, wherein the coating is provided at a rate of about 5 lb./3000 sq. ft. based on the dry weight of the coating composition (as applied to the host media or substrate).

19. A method of utilizing the coating applied to the host media or substrate by:
(a) Printing using a non-contact method such as ink jet or digital printing onto the print side of the host media or substrate which has been coated by any method with a coating comprising:
(i) At least 15 wt. % silica based on the dry weight of the coating composition, and
(ii) At least 5 wt. % binder based on the dry weight of the coating composition;
(b) Combining the host media or substrate and the receiver media and substrate; and
(c) Sublimating or transferring the non-contact printed image or graphic from the host media or substrate to the receiver media or substrate utilizing heat, pressure, vacuum, time and or any combination of one or more of the same.

20. A method according to claim 19, wherein the receiver media or substrate comprises fabric in cut pieces, fabric in bolt form, metal, wood, glass, plastic, or any other material or media that can utilize the process of sublimation and or transfer.

21. A method according to claim 19, wherein the coating composition comprises about 15 wt. % to about 40 wt. % silica based on the dry weight of the coating.

22. A method according to claim 19, wherein the coating composition comprises about 5 wt. % to about 40 wt. % binder based on the dry weight of the coating composition.

23. A method according to claim 19, wherein the coating composition further comprises clay, calcium carbonate, or a mixture of clay and carbonate.
